(19) United States
(12) Patent Application Publication
(10) Pub. No.: US 2015/0266406 A1
(43) Pub. Date: Sep. 24, 2015

(54) TRAILER MOVER

(71) Applicant: Duane Stombaugh, Spring Lake Park, MN (US)

(72) Inventor: Duane Stombaugh, Spring Lake Park, MN (US)

(21) Appl. No.: 14/631,737

(22) Filed: Feb. 25, 2015

Related U.S. Application Data
(60) Provisional application No. 61/944,165, filed on Feb. 25, 2014.

(51) Int. Cl. B60P 3/075; B62D 63/08

(52) U.S. Cl. CPC B60P 3/075; B62D 63/08

(57) ABSTRACT

A trailer mover for moving a trailer by hand includes an assembly for engaging the wheel assembly of a trailer tongue stand, and a detachable handle. The handle provides leverage to pivot and roll the tongue stand wheel assembly, thereby enabling easy hand maneuvering of the trailer.

### RELATED APPLICATIONS

The present application claims priority to U.S. Provisional Application No. 61/944,165, filed Feb. 25, 2014, said application being hereby fully incorporated herein by reference.

### FIELD OF THE INVENTION

The present invention relates to vehicle trailers, and more specifically to devices and methods for moving vehicle trailers by hand.

### BACKGROUND OF THE INVENTION

Trailers for towing various types of vehicles, such as boats, and for transporting cargo on the road are very common. Typically, as depicted in FIGS. 1 and 2, such trailers 20 will have a frame 22 or enclosure 24 for supporting or containing the load, one or more wheel pairs 26 proximate the rear or mid-region of the trailer, and a tongue portion 28 for coupling to a towing vehicle. Especially for heavier trailers, tongue portion 28 may have a stand 30 attached thereto, which can be lowered to engage the ground and support the tongue when the tongue is uncoupled from the towing vehicle. Often, the stand 30 may have an attached wheel assembly 32, and is pivotable to aid in maneuvering the trailer when uncoupled.

A problem with trailers, however, is that they can be difficult to maneuver manually when uncoupled from the towing vehicle. Heaver trailers with large loads may have significant tongue weight, making even those with an attached wheeled stand difficult to roll. Also, it can be difficult to effectively steer the trailer by hand simply by pushing on the tongue. As a result, maneuvering, especially in tight quarters, can be awkward and strenuous. What is needed is an apparatus for maneuvering a trailer by hand that addresses these problems.

### SUMMARY OF THE INVENTION

Embodiments of the present invention address the problems with maneuvering trailers by hand. According to embodiments of the invention, a trailer mover includes a wheel receiver for engaging the wheel assembly of a trailer tongue stand, and a handle that may be of adjustable length or have bends to enable optimal leverage. The handle provides leverage to pivot and roll the wheel assembly, thereby enabling easy hand maneuvering of the trailer.

An embodiment of the invention includes an apparatus for moving a wheeled trailer by hand, wherein the wheeled trailer includes a tongue stand with a wheel assembly operably coupled thereto. The apparatus includes a wheel receiver portion adapted to engage the wheel assembly, and a handle assembly operably coupled to the wheel receiver portion.

A further embodiment of the invention includes an apparatus for moving a wheeled trailer by hand, wherein the wheeled trailer includes a tongue stand with a wheel assembly operably coupled thereto, the wheel assembly including a shaft. The apparatus includes a clamp assembly adapted to engage the shaft and a handle assembly operably coupled to the clamp assembly. In embodiments, the shaft may be generally cylindrical, and the clamp assembly can include a first portion and a second portion mated together and defining a generally cylindrical bore adapted to receive the generally cylindrical shaft of the wheel assembly there through.

In embodiments of the invention, the handle assembly has a hook portion a distal end thereof, and the first portion or the second portion of the clamp assembly presents a pair of opposing pivot pins, the hook portion of the handle assembly being pivotally engaged with the pair of pivot pins. The hook portion may have a generally cylindrical portion defining a bore therethrough. The generally cylindrical portion of the hook portion may have a pair of notches at opposing ends for enabling engagement with the pivot pins. The bore defined by the mated halves of the clamp assembly has a first portion with a first diameter and a second portion with a second diameter, the second diameter being larger than the first diameter. The bore may have a third portion disposed between the first portion and the second portion, the walls of the third portion being tapered.

In an embodiment a trailer includes a frame presenting a tongue, the tongue having a wheel assembly with a shaft, at least one pair of wheels operably coupled to the frame, and a trailer mover operably coupled to the shaft, the trailer mover including a clamp assembly adapted to engage the shaft, a handle assembly operably coupled to the clamp assembly.

In embodiments of the trailer, the shaft is generally cylindrical and the clamp assembly includes a first portion and a second portion mated together and defining a generally cylindrical bore adapted to receive the generally cylindrical shaft of the wheel assembly therethrough.

In embodiments of the trailer, the handle assembly has a hook portion at a distal end thereof, and the first portion or the second portion of the clamp assembly presents a pair of opposing pivot pins, the hook portion of the handle assembly being pivotally engaged with the pair of pivot pins. The hook portion may have a generally cylindrical portion defining a bore therethrough. The generally cylindrical portion of the hook portion can have a pair of notches at opposing ends for enabling engagement with the pivot pins.

In embodiments of the trailer, the bore can have a first portion with a first diameter and a second portion with a second diameter, the second diameter being larger than the first diameter. A third portion may be disposed between the first portion and the second portion, the walls of the third portion being tapered.

### BRIEF DESCRIPTION OF THE DRAWINGS

The invention can be understood in consideration of the following detailed description of various embodiments of the invention in connection with the accompanying drawings, in which:

FIG. 1 is a perspective view of a prior art boat trailer;

FIG. 2 is a perspective view of a prior art enclosed trailer;

FIG. 3 is a front isometric view of a trailer mover according to an embodiment of the invention;

FIG. 4 is a rear isometric view of the trailer mover of FIG. 3;

FIG. 5 is an exploded view of the trailer mover of FIG. 3;

FIG. 6 depicts a trailer mover according to an embodiment of the invention engaged with a wheeled stand on the tongue of a trailer;

FIG. 7 is a top view of the trailer mover of FIG. 6 engaged with the wheeled stand of a trailer;

FIG. 8 is a depiction of the trailer mover and wheeled stand of FIG. 7 from another perspective;

FIG. 9 is a front top view depiction of the trailer mover and wheeled stand of FIG. 7;

FIG. 10 is an isometric view of a trailer mover and wheeled stand according to another embodiment of the invention;

FIG. 11 is a top plan view of a clamp assembly of the trailer mover of FIG. 10 with fasteners shown in phantom view;

FIG. 12 is a cross-section of the clamp assembly of FIG. 11 taken at section 12-12 of FIG. 11;

FIG. 13 is a side elevation view of the clamp assembly of FIG. 11;

FIG. 14 is a side elevation view of a hook portion of the handle assembly of the trailer mover of FIG. 10;

FIG. 15 cross-sectional view of the coupling of the handle assembly with the clamp assembly of the trailer mover of FIG. 10 taken at section 15-15 of FIG. 10;

FIG. 16 is a bottom perspective view of the coupling of the handle assembly with the clamp assembly of the trailer mover of FIG. 10;

FIG. 17 is a top plan view of the hook portion of the handle assembly of the trailer mover of FIG. 10;

FIG. 18 is an elevation view of the distal end of the hook portion of the handle assembly of the trailer mover of FIG. 10; and

FIG. 19 is a front elevation view of the rear clamp portion of the clamp assembly of FIG. 11.

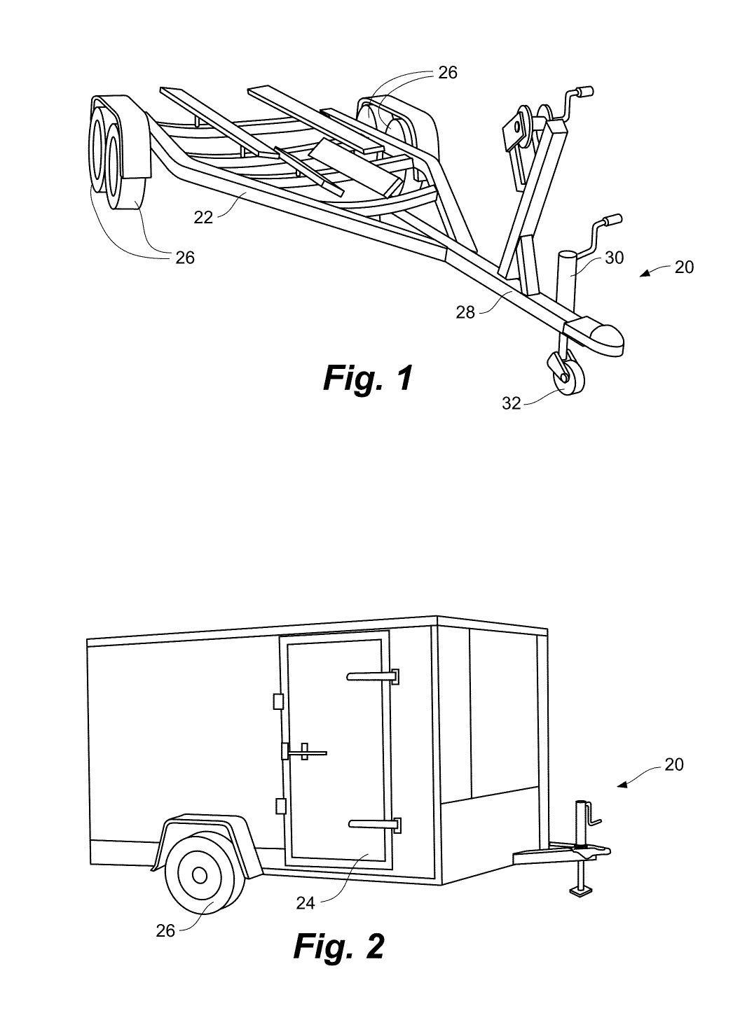

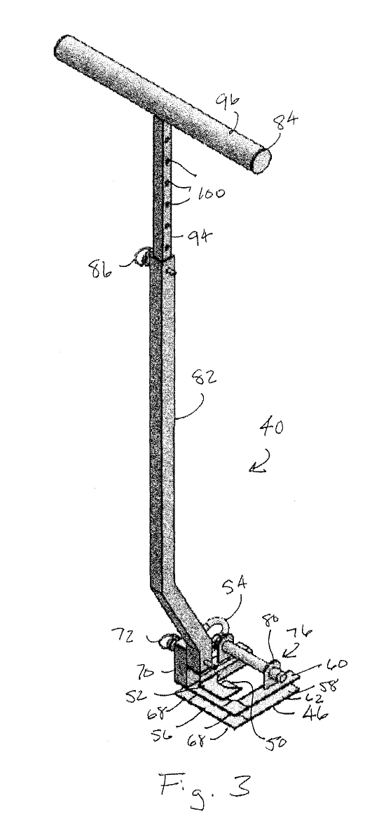

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

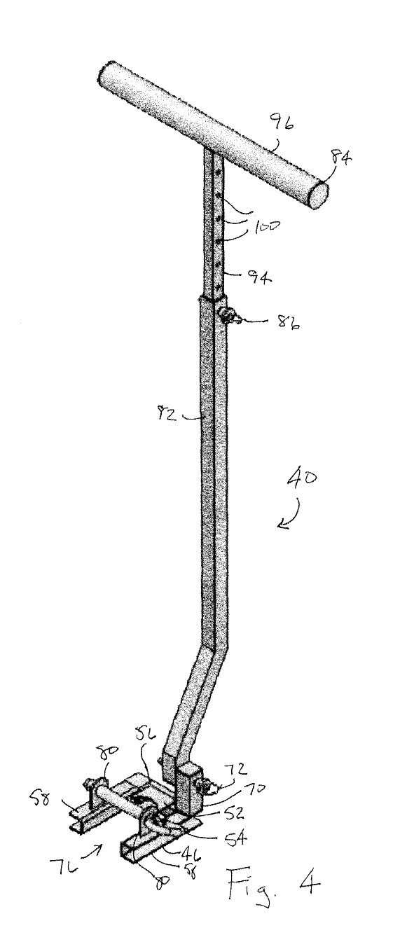

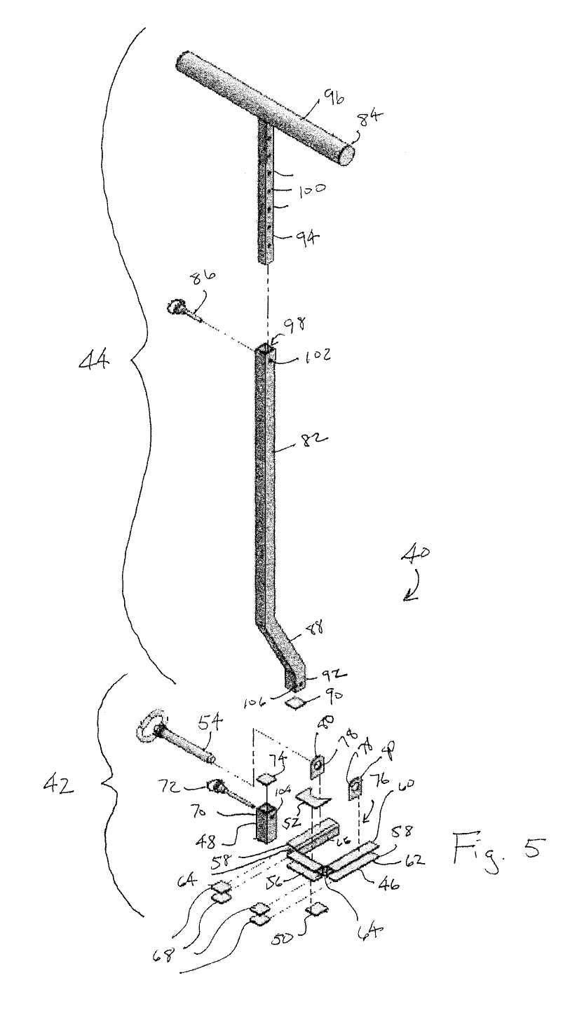

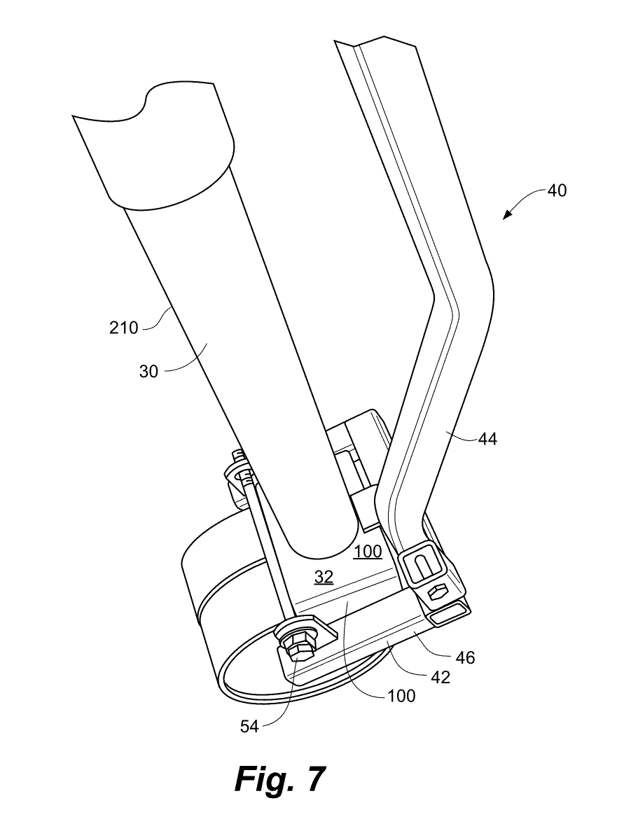

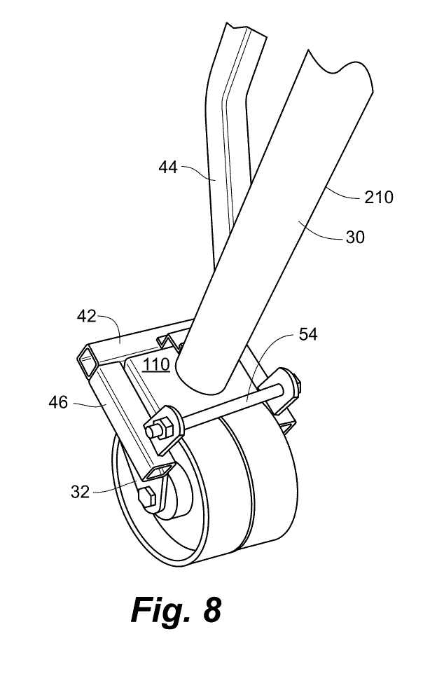

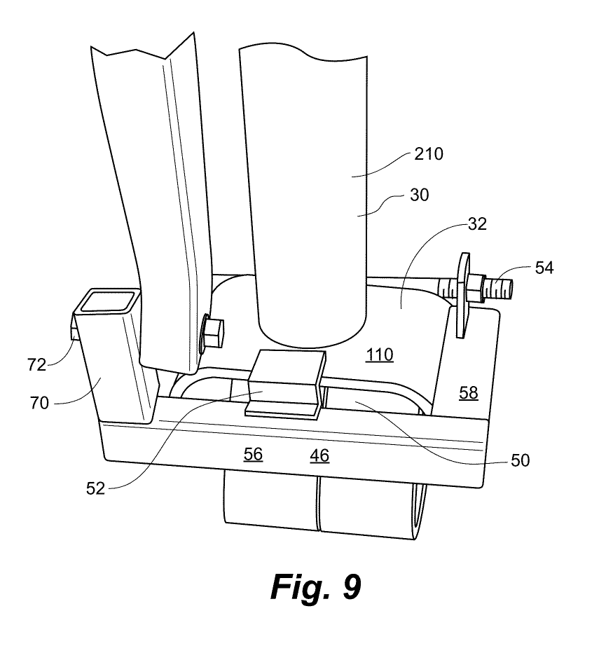

There is depicted in FIGS. 3-9 a trailer mover 40 according to an embodiment of the invention. Trailer mover 40 generally includes wheel receiver 42 and handle assembly 44.

Wheel receiver 42 generally includes u-shaped frame 46, handle interface 48, wheel retaining tabs 50, 52, and retaining pin 54. Frame 46 generally includes front rail 56 and forwardly projecting parallel side rails 58, and can be formed from steel channel material by cutting upper and lower flanges 60, 62, at each of comers 64 and bending web portion 66 to form the u-shape. Filler tabs 68 can be welded at each of comers 64 as depicted in FIG. 3 so as to lend strength to the frame.

Handle interface 48 generally includes receiving post 70 and handle retaining pin 72. Receiving post 70 is permanently affixed to frame 46 and extends upwardly as depicted in FIG. 4. Cap 74 can be provided to lend a finished appearance to receiving post 70. Wheel retaining tabs 50, 52, are affixed to front rail 56 of frame 46 and extend into u-shaped opening 76 defined by frame 46. Upper tab 52 is vertically spaced apart from lower tab 50 so as to define a gap for receiving the horizontal flange of a wheel assembly of a trailer tongue stand as will be further described hereinbelow. Retaining pin 54 is removably received through apertures 78 defined in pin carrier tabs 80 that extend upwardly from side rails 58.

Handle assembly 44 generally includes handle shaft 82, T-handle 84, and pin 86. Handle shaft 82 may be formed from square steel tube material, and may include offset portion 88. Cap 90 may be welded in end 92 to close the open bottom of the tube. T-handle 84 generally includes shaft portion 94 and handle 96. Shaft portion 94 can be formed from square steel tube material and is sized so as to be slidably receivable in top opening 98 of handle shaft 82. Shaft portion 94 defines a plurality of apertures 100, that are registerable with apertures 102 in handle shaft 82. Pin 86 is receivable through apertures 100, 102, to secure T-handle 84 to handle shaft 82 and provide length adjustment for handle assembly 44. Handle assembly 44 is secured to wheel receiver 42 with handle retaining pin 72 extending through apertures 104 in receiving post 70 and apertures 106 in handle shaft 82.

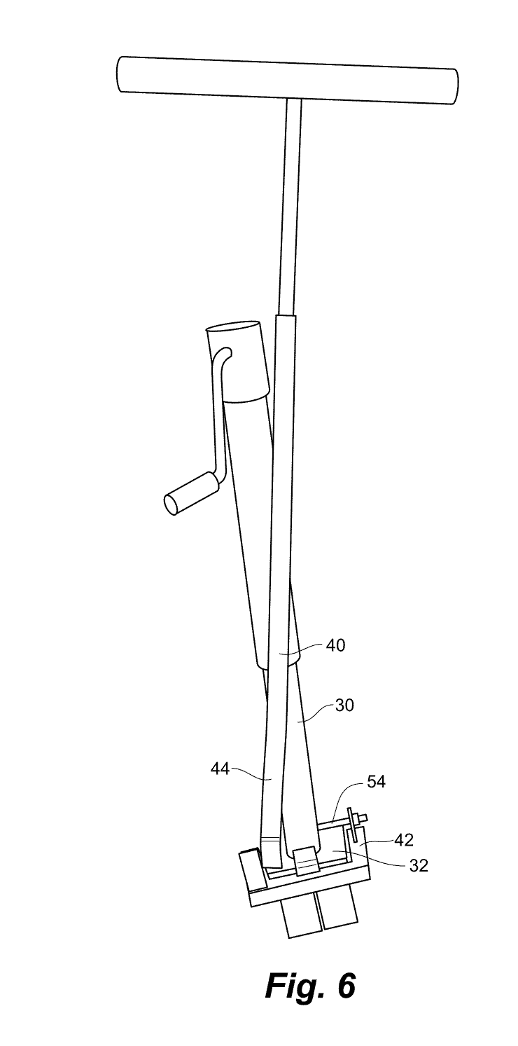

In use, trailer mover 40 is engaged with a wheel assembly 32 of a trailer tongue stand 30 as depicted in FIGS. 6-9. Wheel carrier 108 is received in u-shaped opening 76 defined by frame 46. Retaining pin 54 may be moved to enable frame 46 to be fitted around wheel carrier 108 and reinserted to retain wheel carrier 108 in place. Horizontal flange 110 of wheel carrier 108 is received in the gap between lower tab 50 and upper tab 52 so as to vertically locate wheel carrier 108 relative to frame 46. It will be appreciated that with trailer mover 40 so attached to wheel assembly the trailer can be easily pushed, steered, and maneuvered using handle assembly 44.

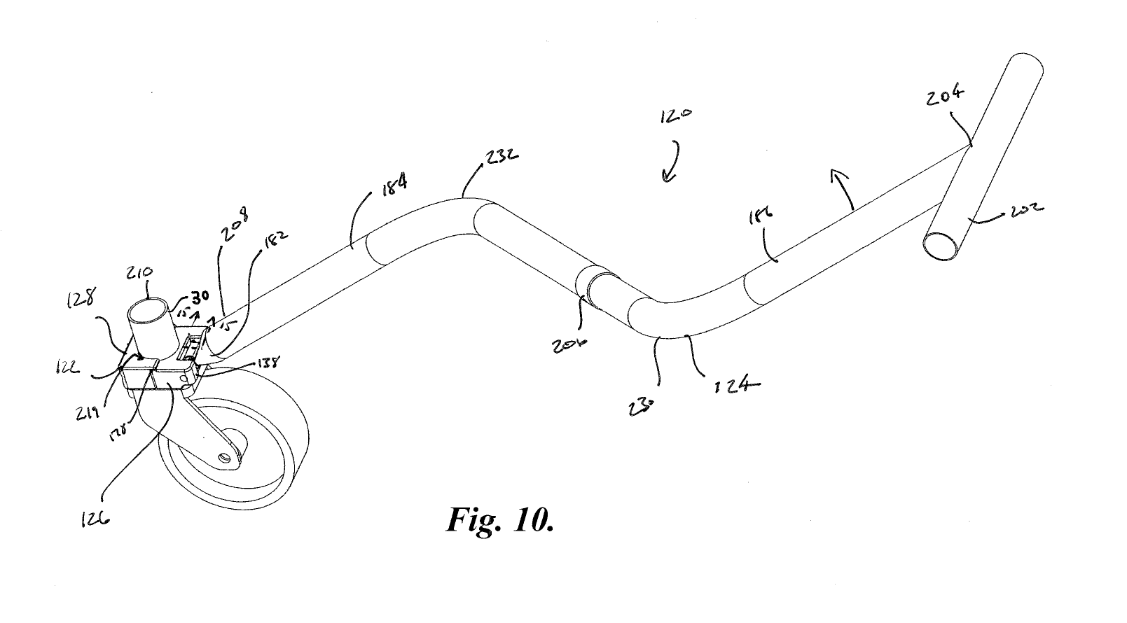

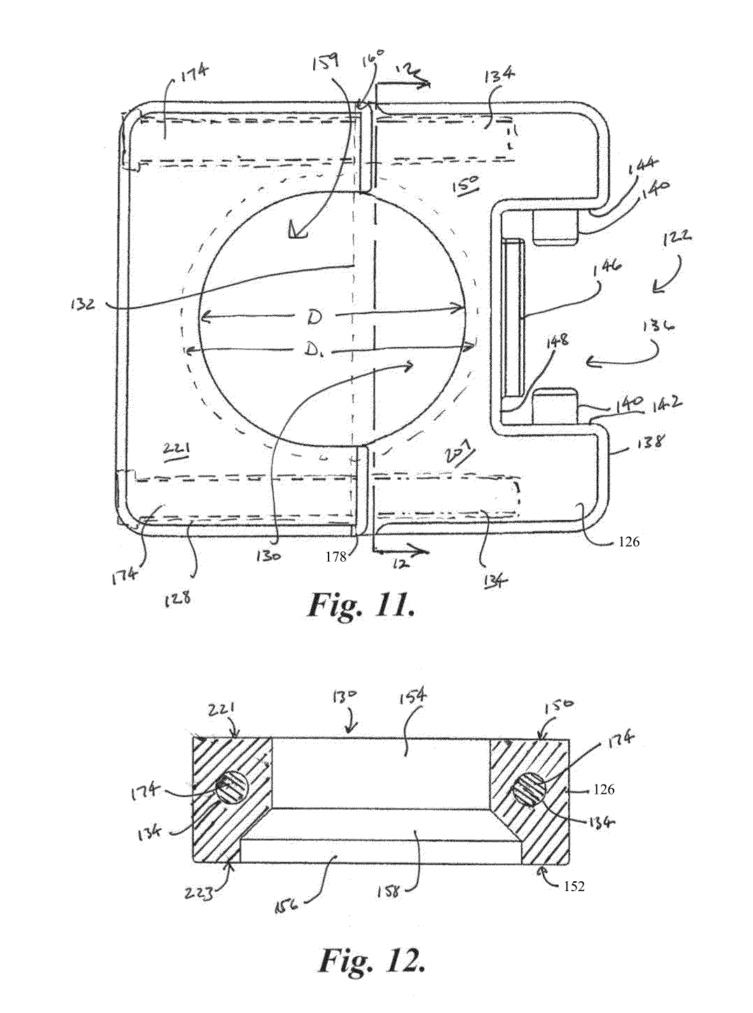

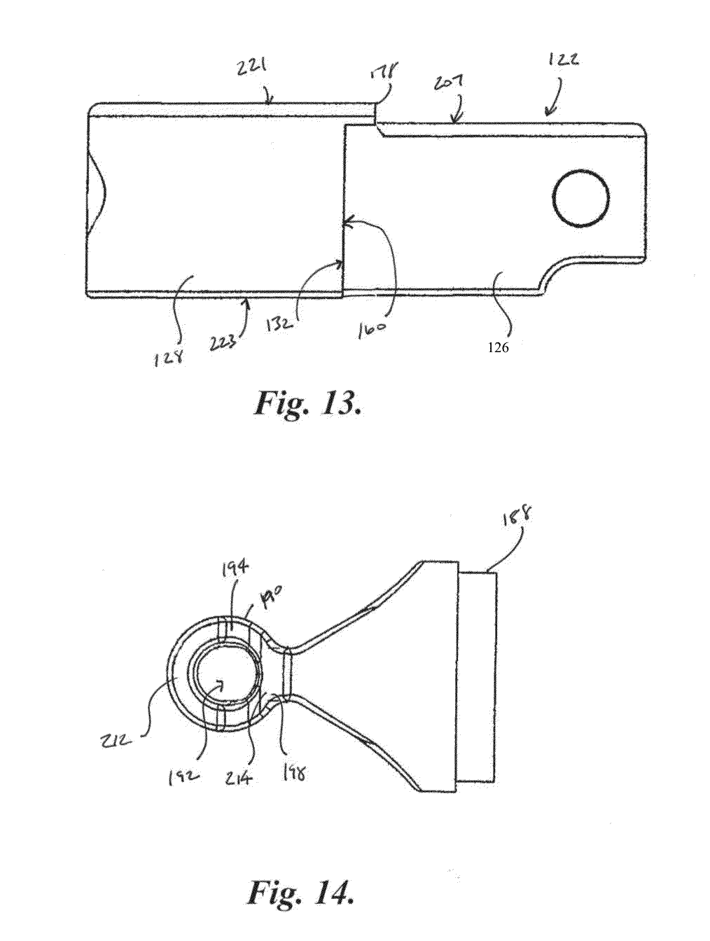

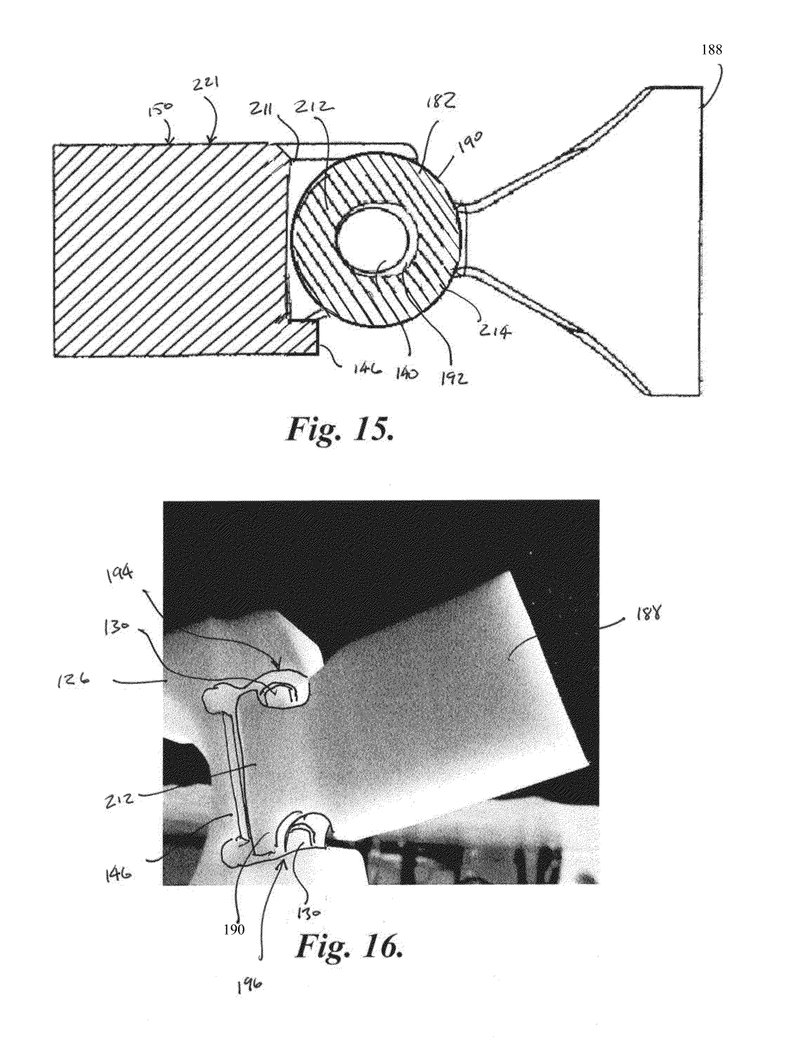

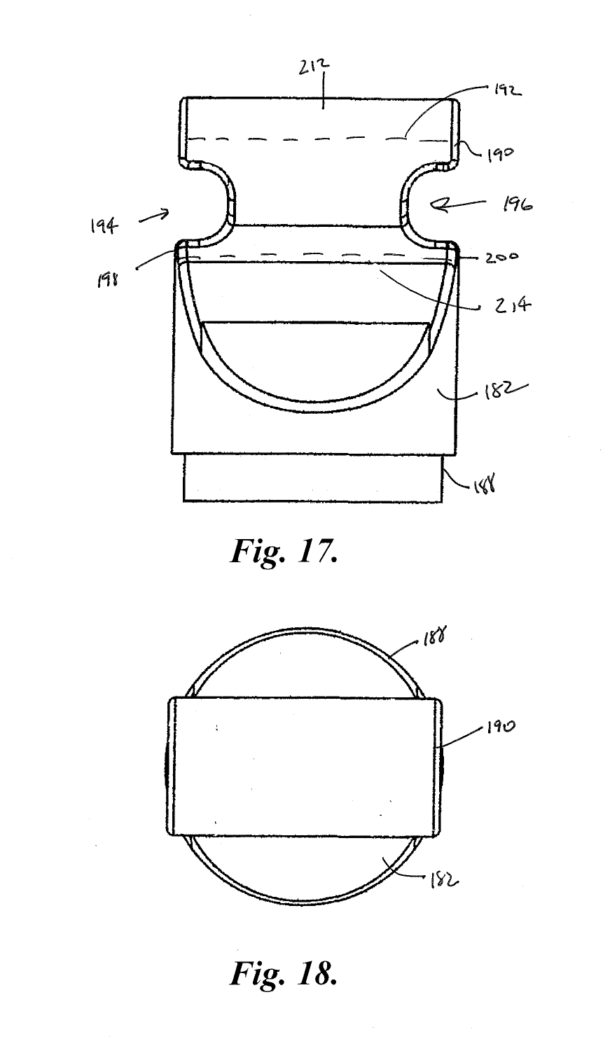

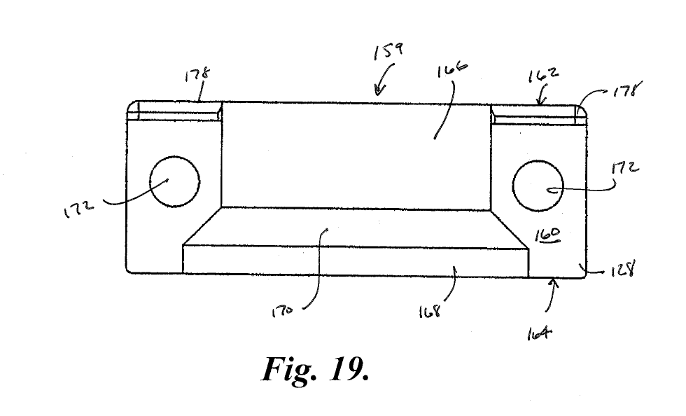

FIGS. 10-19 depict another embodiment of a trailer mover 120. Trailer mover 120 generally includes clamp assembly 122 and handle assembly 124.

Clamp assembly 122 generally includes front clamp portion 126 and rear clamp portion 128. Front clamp portion 126 defines semi-circular recess 130 in rear side 132, and threaded apertures 134 extending from rear side 132. Handle receiving recess 136 is defined in front side 138. Opposing pivot pins 140 extend into recess 136 from each of opposing recess sides 142, 144, and retaining lip 146 extends into recess 136 from front recess wall 148. Semi-circular recess 130 extends from top side 150 to bottom side 152, and includes first portion 154, second portion 156, and a tapered or chamfered portion 158 extending between first portion 154 and second portion 156.

Rear clamp portion 128 defines semi-circular recess 159 in front side 160. Semi-circular recess 159 extends from top side 162 to bottom side 164, and includes first portion 166, second portion 168, and a tapered or chamfered portion 170 extending between first portion 166 and second portion 168. Rear clamp portion 128 also defines apertures 172 for receiving fasteners 174 to fasten rear clamp portion 12.8 to front clamp portion 126. Fasteners 174 are depicted as bolts, but could also be studs with suitable retaining nuts or any other fasteners as are known in art. Front side 160 has projecting lip 178 at top edge 180.

Handle assembly 124 generally includes hook portion 182, lower handle 184, and upper handle 186. Hook portion 182, as depicted in FIGS. 14 through 18, generally includes shaft interface portion 188, and clamp interface portion 190. Clamp interface portion 190 is generally cylindrical and defines bore 192 extending laterally therethrough. Notches 194, 196, are defined. in opposing lateral sides 198, 200, of clamp interface portion 190. Upper handle 186 can include T-shaped portion 202 at proximal end 204. Upper handle 186 and lower handle 184 may have bends 230 and 232 respectively in order to provide better leverage to a user in pushing a trailer by hand, or to clear obstacles presented by the trailer itself or items loaded on the trailer. Upper handle 186 is coupled to lower handle 184 at connection 206, and hook portion 182 is coupled to lower handle 184 at distal end 208 of lower handle 184.

In use, clamp assembly 122 is secured to the tubular shaft 210 of trailer tongue stand 30 by mating rear side 132 of front clamp portion 126 with front side 160 of rear clamp portion 128, such that tubular shaft 210 extends through the circular bore 219 formed by semi-circular recesses 130, 159. Circular bore 219 has a diameter D as defined by first portions 154, 166, at top side 221 of clamp assembly 122, and larger diameter D1, as defined by second portions 156, 168, at bottom side 223. Projecting lip 178 of rear clamp portion 128 slightly overlaps top side 207 of front clamp portion 126. Second portion 156 and chamfered portion 158 of semi-circular recess 130 of front clamp portion 126, and second portion 168 and chamfered portion 170 of semi-circular recess 159 of rear clamp portion 170 together provide space to receive any weldments or fasteners securing tubular shaft 210 to horizontal flange 110 of wheel carrier 108. Fasteners 174 can then be tightened to secure clamp assembly 122 around tubular shaft 210. Handle assembly 124 can then be attached to clamp assembly 122 by inserting hook portion 182 into recess 136 of front clamp portion 124 such that pivot pins 140 pass through notches 194, 196. With pivot pins 140 registered with bore 192, handle assembly 124 can be rotated upward in the direction of the arrow in FIG. 10. In this position, pivot pins 140 are disposed between front wall 212 and back wall 214 of hook portion 182, and the locations of retaining lip 146 and upper corner 211 of front edge of recess 136 unintended disengagement of handle assembly 122 from clamp assembly 124. It will be appreciated that with trailer mover 120 so attached to trailer tongue stand 30, the trailer can be easily pushed, steered, and maneuvered. Handle assembly 122 can be easily detached from clamp assembly 124 by rotating handle assembly 122 downward, and lifting so that pivot pins 140 pass back through notches 194, 196.

It will be appreciated by those of skill in the art that, as an alternative to coupling front clamp portion 126 and rear clamp portion 128, clamp assembly 122 could be formed in one piece.

The embodiments above are intended to be illustrative and not limiting. Additional embodiments are within the scope of the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

For purposes of interpreting the claims for the present invention, it is expressly intended that the provisions of Section 112(f) of 35 U.S.C. are not to be invoked unless the specific terms “means for” or “step for” are recited in a claim.

What is claimed is:

1. An apparatus for moving a wheeled trailer by hand, the wheeled trailer including a tongue stand with a wheel assembly operably coupled thereto, the apparatus comprising:
a wheel receiver portion adapted to engage the wheel assembly; and
a handle assembly operably coupled to the wheel receiver portion.

2. An apparatus for moving a wheeled trailer by hand, the wheeled trailer including a tongue stand with a wheel assembly operably coupled thereto, the wheel assembly including a shaft, the apparatus comprising:
a clamp assembly adapted to engage the shaft; and
a handle assembly operably coupled to the clamp assembly.

3. The apparatus of claim the shaft is generally cylindrical and wherein the clamp assembly includes a first portion and a second portion mated together and defining a generally cylindrical bore adapted to receive the generally cylindrical shaft of the wheel assembly therethrough.

4. The apparatus of claim 3, wherein the handle assembly has a hook portion at a distal end thereof, and wherein the first portion or the second portion of the clamp assembly presents a pair of opposing pivot pins, the hook portion of the handle assembly being pivotally engaged with the pair of pivot pins.

5. The apparatus of claim 4, wherein the hook portion has a generally cylindrical portion defining a bore therethrough.

6. The apparatus of claim 5, wherein the generally cylindrical portion of the hook portion has a pair of notches at opposing ends for enabling engagement with the pivot pins.

7. The apparatus of claim 3, wherein the bore has a first portion with a first diameter and a second portion with a second diameter, the second diameter being larger than the first diameter.

8. The apparatus of claim 7, wherein the bore has a third portion disposed between the first portion and the second portion, the walls of the third portion being tapered.

9. The apparatus of claim 2, wherein a length of the handle assembly is selectively adjustable.

10. A trailer comprising:
a frame presenting a tongue, the tongue having a wheel assembly with a shaft;
at least one pair of wheels operably coupled to the frame; and
a trailer mover operably coupled to the shaft, the trailer mover comprising:
a clamp assembly adapted to engage the shaft; and
a handle assembly operably coupled to the clamp assembly.

11. The trailer of claim 10, wherein the shaft is generally cylindrical and wherein the clamp assembly includes a first portion and a second portion mated together and defining a generally cylindrical bore adapted to receive the generally cylindrical shaft of the wheel assembly therethrough.

12. The trailer of claim 11, wherein the handle assembly has a hook portion at a distal end thereof, and therein the first portion or the second portion of the clamp assembly presents a pair of opposing pivot pins, the hook portion of the handle assembly being pivotally engaged with the pair of pivot pins.

13. The trailer of claim 12, wherein the hook portion has a generally cylindrical portion defining a bore therethrough.

14. The trailer of claim 13, wherein the generally cylindrical portion of the hook portion has a pair of notches at opposing ends for enabling engagement with the pivot pins.

15. The trailer of claim 11, wherein the bore has a first portion with a first diameter and a second portion with a second diameter, the second diameter being larger than the first diameter.

16. The trailer of claim 15, wherein the bore has a third portion disposed between the first portion and the second portion, the walls of the third portion being tapered.

17. The trailer of claim 10, wherein a length of the handle assembly adjustable.
